(19) United States
(12) Patent Application Publication
(10) Pub. No.: US 2020/0374327 A1
(43) Pub. Date: Nov. 26, 2020

(54) SYSTEM AND METHOD OF ALWAYS-ON IMMERSIVE VIDEO PORTAL

(71) Applicant: Daryl Hutchings, Bristol (GB)

(72) Inventor: Daryl George Hutchings, Bristol (GB)

(21) Appl. No.: 16/416,691

(22) Filed: May 20, 2019

(51) Int. Cl. H04L 29/06

(52) U.S. Cl. CPC H04L 65/403; H04L 65/1083; H04L 65/1096

(57) ABSTRACT

A system of an always-on immersive video portal is provided. The system comprises a first monitor and a second monitor, each monitor containing microphone and speaker functionality. The system also comprises a processor, a memory, and an application stored in the memory. When executed on the processor, the application maintains a persistent bidirectional video session between the first and second monitors with audio transmission functionality of the monitors disabled by default. The application also detects input of a first manual entry to one of the first monitor and the second monitor. The application also enables, based on the detection, bidirectional audio transmission between the first monitor and the second monitor. The application also detects input of a second manual entry to one of the first monitor and the second monitor and disables, based on the detection, the bidirectional audio transmission.

### FIELD OF THE INVENTION

The present disclosure is in the field of communications. More particularly, the present disclosure provides for selective two-way voice communication between at least two video monitors that maintain a persistent video session.

### BACKGROUND

Groups of persons in geographically distant offices may need to work collaboratively on a short term and impromptu basis. During a workday, persons in one office may need to communicate briefly via at least audio contact with persons in another, distant office.

Traditional conference calls using speaker phones are impersonal as participants cannot see one another and are not confident of the identities of all parties on the call. Steps for arranging conference calls on speaker phones can be complicated. Participants can be accidentally cut off or be unaware that their microphones are not muted at times. Further, sound quality on speaker phones is hampered by echoing and ringing noise characteristics.

While conference calling involving video and audio together may be available, for most large organizations with multiple offices such calling must be done from conference rooms with dedicated hardware. Parties wishing to make such calls usually must reserve the conference room well in advance for a specific start and end time and must be able to operate the hardware. Usually the parties must specify participants and set up conference call IDs and enter passwords or other credentials. These restrictions discourage the impromptu type of collaborative communication that groups often desire.

### BRIEF DESCRIPTION OF THE DRAWINGS

FIG. 1 is a block diagram of a system of always-on immersive video portal according to an embodiment of the present disclosure.

### DETAILED DESCRIPTION

Systems and methods described herein provide for at least two geographically distant monitors to be in a persistent video session but with two-way audio functionality off by default and only enabled by simple, deliberate action. Each monitor remains powered on and steadily displays video content captured by the other monitor but with audio disabled by default for both monitors.

When an authorized person or group at one location seeks to communicate with a person or group at the other location, the person may merely tap on a display area of the monitor at his/her own location. This action enables two-way audio communication between the two locations to accompany the persistently-on video session between the two monitors. The parties may commence a full video and audio meeting for as long as they wish with only the tapping action needed.

When finished, another manual tap on either of the video monitor screens disables the two-way audio functionality. Two-way but silent video functionality remains enabled as previously.

Systems and methods are directed to informal and impromptu communications between groups situated in common area, for example open office spaces with low cubicles. Personnel in a New York office and a London office of a company may need to be in near constant daily contact. They may wish to have brief impromptu meetings to discuss, for example, a problem with a customer account.

Finding an available conference room, scheduling the conference room for a specific start and end time, and accounting for time differences between participants can be burdensome. Further, assuring that audio and video equipment are working, and dealing with passwords, meeting IDs and codes can all be onerous and time consuming when a brief impromptu meeting for perhaps ten minutes in duration is needed.

Geographically separate groups that desire short, impromptu meetings cannot deal conveniently with conventional conference room arrangements and may further wish to remain working in their common areas while impromptu meetings are taking place. Monitors located in common areas that are constantly in video contact and available for two-way and relatively brief audio use are better suited for the impromptu, unscheduled and collaborative nature of interactions between workgroups that organizations presently desire.

In embodiments, more than two locations may have monitors in common areas. Systems and methods provided herein are configurable to allow, for example, any two of three or more total monitors to have impromptu audio and video sessions as described above. Alternatively, all three locations may engage in a single session as described above.

In embodiments, locations may enable only a speaker and not a microphone if they wish to listen only. Locations may also enable a microphone only and keep their speaker disabled.

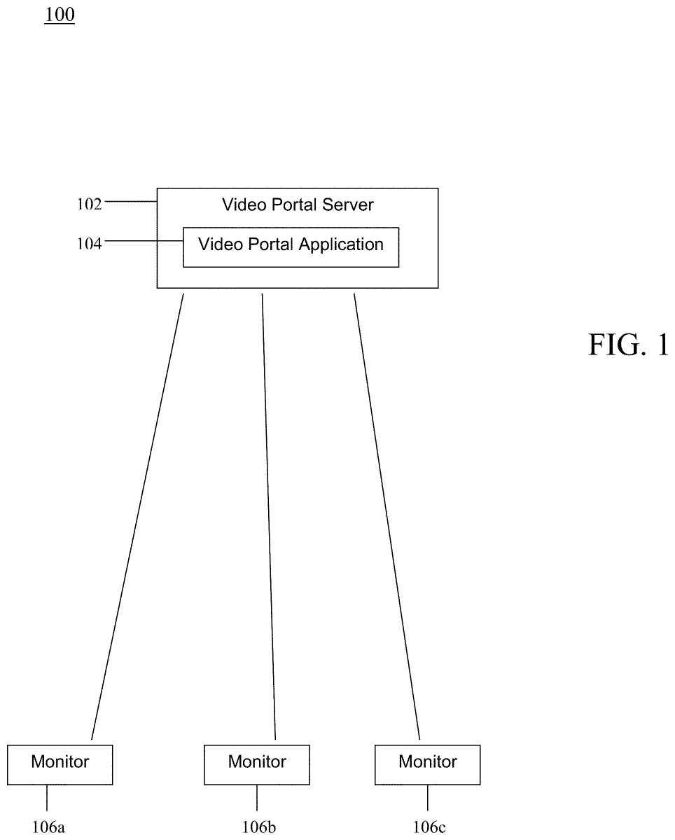

Turning to the FIGURE, FIG. 1 is a block diagram of a system of always-on immersive video portal according to an embodiment of the present disclosure. FIG. 1 depicts components and interactions of a system 100 including a video portal server 102 and a video portal application 104, referred to for brevity as the server 102 and the application 104.

The system also comprises monitors 106a-c that may be situated at distant geographic locations, such as in branch offices of an organization. While three monitors 106a-c are shown, in embodiments only two or four or more monitors 106a-c may be in effect. The monitors 106a-c may have built-in microphone and speaker functionality. Each monitor 106a-c may have specific areas on their screens where a user may tap or otherwise activate to turn on audio functionality as described above.

In an embodiment, tapping a predetermined area of a screen of a monitor 106a-c may cause an interface to appear. Such interface may provide selectable areas or objects for selecting which other monitor 106a-c the selecting party wants to communicate with as well as choose to turn on the microphone, speaker, or both devices.

The application 104 executes on the server 102 and may be used to configure the monitors 106a-c as described above as well as configure permissions for various users to take certain actions such as cause a whiteboard to be overlaid on viewing areas of monitors 106a-c. The application 104 includes an overnight sleep mode that can be configured by the administrator. The application 104 will automatically turn monitors 106a-c completely on and off at set times to conserve power and bandwidth.

Systems and methods include a SIP video dialer that will allow a user to leave window mode and make an external call to whatever meeting service the user wants, for example Cisco Webex, Zoom, BlueJeans, Pexip, Cisco Meeting Server, and Ubiety. Dependent on the gateways of an organization, systems and methods provide for connecting to Skype for business, Microsoft Teams and Google Hangouts/Google Meet.

Even though video is on by default, as noted the audio is off at each location for both microphone and speaker, meaning the only time a site can hear and be heard is when someone is physically standing at the monitor 106a and has pressed the join audio button. At times users may unmute, have their conversation and forget to terminate the audio. Systems and methods provide a timer that will automatically disconnect the audio after a set time.

Systems and methods will only allow other monitors 106a-c within its configured group to see each other. If users are using a common area for another event and don't want that to be visible to the other locations, the users can manually set a privacy timer that will turn off all video/audio in both directions on the device for a set time. Once the time is up, it will automatically reconnect with audio muted as described above.

1. A system of an always-on immersive video portal, comprising:
a first monitor and a second monitor, each monitor containing microphone and speaker functionality;
a processor;
a memory;
an application stored in the memory that when executed on the processor:
maintains a persistent bidirectional video session between the first and second monitors with audio transmission functionality of the monitors disabled by default;
detects input of a first manual entry to one of the first monitor and the second monitor;
enables, based on the detection, bidirectional audio transmission between the first monitor and the second monitor;
detects input of a second manual entry to one of the first monitor and the second monitor; and
disables, based on the detection, the bidirectional audio transmission.

2. The system of claim 1, wherein the entries to the first monitor and the second monitor comprise manual taps to predetermined display areas of the monitors.

3. The system of claim 1, wherein the first and second monitors are situated in geographically distant locations.

4. The system of claim 1, wherein the first and second monitors are situated in common areas of offices accessible by large numbers of persons.

5. The system of claim 1, wherein accessing voice functionality between the monitors is done without scheduling.

6. The system of claim 1, wherein a whiteboard is overlaid on screens of at least the first and second monitors during a voice session.

7. The system of claim 1, wherein when the manual entry is made to the first monitor, the second monitor emits a sound, the sound alerting users of the second monitor that an audio session has been initiated.

8. A method for always-on immersive video portal communication, comprising:
a computer maintaining a persistent bidirectional video session between a first and an second monitor with audio transmission functionality between the monitors disabled by default;
the computer detecting input of a first manual entry to one of the first monitor and the second monitor;
the computer enabling, based on the detection, bidirectional audio transmission between the first monitor and the second monitor;
the computer detects input of a second manual entry to one of the first monitor and the second monitor; and
the computer disabling, based on the detection, the bidirectional audio transmission.

9. The method of claim 8, wherein the entries to the first monitor and the second monitor comprise manual taps to predetermined display areas of the monitors.

10. The method of claim 8, wherein the first and second monitors are situated in geographically distant locations.

11. The method of claim 8, wherein the first and second monitors are situated in common areas of offices accessible by large numbers of persons.

12. The method of claim 8, wherein accessing voice functionality between the monitors is done without scheduling.

13. The method of claim 8, further comprising overlaying a whiteboard on screens of at least the first and second monitors during a voice session.

14. The method of claim 8, wherein when the manual entry is made to the first monitor, the second monitor emits a sound, the sound alerting users of the second monitor that an audio session has been initiated.

15. A method for always-on immersive video portal communication, comprising:
a first monitor in a persistent bidirectional video-only session with a second monitor receiving a first tactile input on a screen surface;
the first monitor, based on the tactile input, enabling bidirectional audio communication with the second monitor;
the first monitor receiving a second tactile input; and
the first monitor, based on receiving the second input, terminating the bidirectional audio communication while maintaining the video-only session.

16. The method of claim 15, further comprising the second monitor emitting an audible sound upon the bidirectional audio communication being enabled.

17. The method of claim 15, wherein the first monitor and the second monitor are situated in open offices distant from one another.

18. The method of claim 15, further comprising overlaying a whiteboard on screens of at least the first and second monitors during a bidirectional audio session.

19. The method of claim 15, further comprising a third monitor joining bidirectional audio sessions with at least one of the first monitor and the second monitor.

20. The method of claim 19, wherein the third monitor engages in bidirectional video and audio sessions with a fourth monitor separate from actions of the first monitor and the second monitor.
